(19) United States
(12) Patent Application Publication
(10) Pub. No.: US 2011/0043459 A1
(43) Pub. Date: Feb. 24, 2011

(54) DISPLAY INTEGRATED WITH TOUCH CONTROL FUNCTION

(75) Inventor: KIM-YEUNG SIP, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (TW); HON HAI PRECISION INDUSTRY CO., LTD., Tu-Cheng (TW)

(21) Appl. No.: 12/610,380

(22) Filed: Nov. 2, 2009

(30) Foreign Application Priority Data
Aug. 20, 2009 (CN) 200910305834.2

(51) Int. Cl. G06F 3/041

(52) U.S. Cl. 345/173

(57) ABSTRACT

A display panel with partial touch film includes a display panel, a touch film, and a video source. The display panel is divided into a main display area and an secondary display area, the main display area is larger than the secondary display area. The transparent touch film is mounted on the secondary display area. The controller is electrically connected between the display panel and the touch film. The video source electrically connects with the display panel and the touch film. The video source generates different commands according to different type of operation performed on the touch film, and controls display contents of the main display area and the secondary display area according to the commands.

### BACKGROUND

1. Technical Field

The present disclosure relates to displays and, particularly, to a large-size display integrated with touch control function.

2. Description of Related Art

Usually in touch screen displays, the touch screen is generally integrated over the entire display for detecting the presence and location of a touch within the display area. However, for large touch screen display, it is inconvenient to use touch screen because touching two extreme points on the display will require that the user has to move his arm instead of just his fingers and in some cases such as 50+ inches display, the user may not be able to touch all areas of the display.

Therefore, a display which can overcome the above-described problems is desired.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a schematic view of a display, according to the present disclosure.

FIG. 2 is a front view of the display of FIG. 1.

FIG. 3 is a front view of the display of FIG. 1, which a secondary display area of the display is activated.

### DETAILED DESCRIPTION

Embodiments of the present display integrated with touch control function will now be described in detail with reference to the drawings.

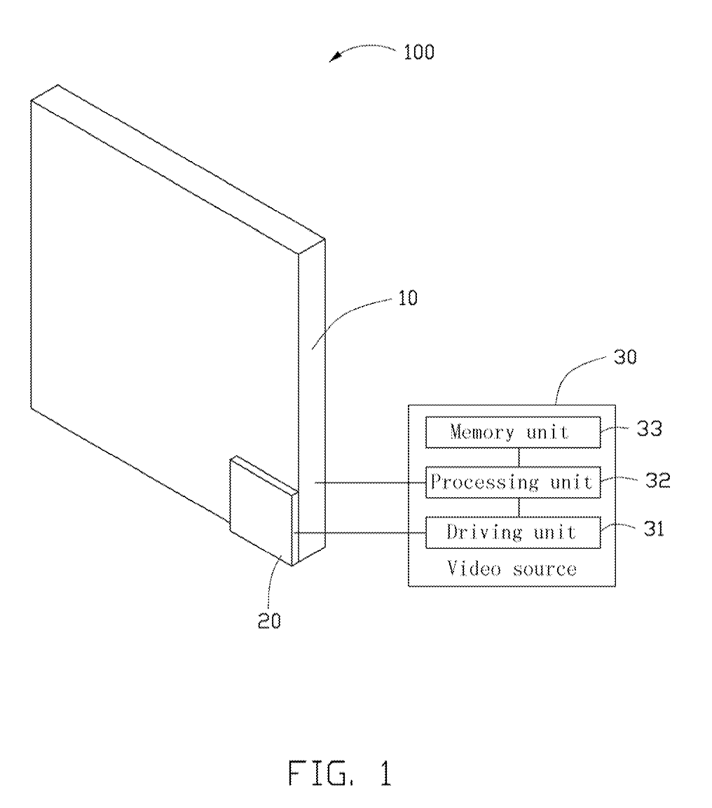

Referring to FIG. 1, a display 100, according to an exemplary embodiment, includes a display panel 10, a touch film 20, and a video source 30.

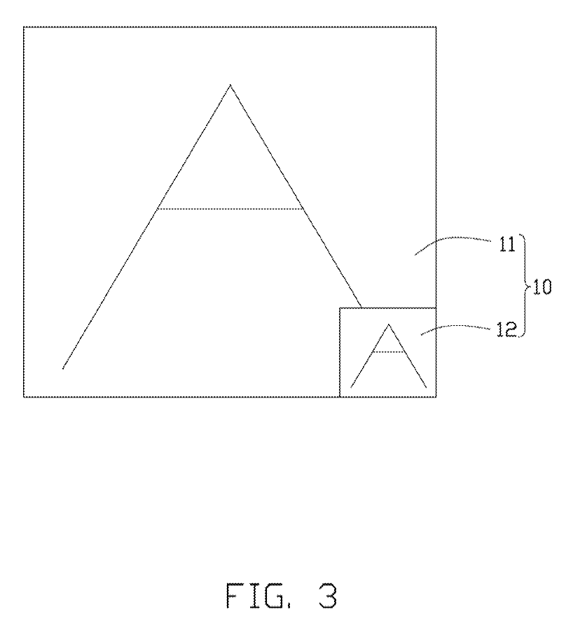

The display panel 10, such as a liquid crystal display (LCD) panel, is divided into a main display area 11 and a secondary display area 12 (see FIG. 3). The main display area 11 is larger than the secondary display area 12. For example, for higher visual effect, the size of the main display area can reach about 54 inches. However, the size of the secondary display area 12 should be limited to a range that facilitates for touch operations thereon, for example, 10 inches. In this embodiment, both the display panel 10 and the secondary display area 12 are rectangular in shape. The secondary display 12 is located at a corner of the display panel, e.g., the right-bottom corner of the display panel 10. Except the secondary display area 12, the rest area of the display panel 10 can function as the main display area 11.

The position of the secondary display area 12 is not limited to this embodiment. Alternatively, the secondary display area 12 can be positioned at other portions of the display panel 10 where the readability of the main display area 11 is not greatly influenced by the secondary display area 12.

The touch film 20 is transparent and shaped corresponding to the secondary display area 12. The touch film 20 is adhered to the secondary display area 12 and for detecting a touch operation thereon and a corresponding control signal is generated. For example, the touch film 20 is a layer of transparent conductor such as indium tin oxide (ITO).

In other alternative embodiments, two independent displays can be used. One functions as the main display area 11 and the other functions as the secondary display area 12. Further alternatively, a display and a touch panel can be employed instead. The display functions as the main display area 10. The touch panel functions as the secondary display area 12 and the touch film 20.

The video source 30, such as a host of a computer, includes a driving unit 31, a processing unit 32, and a memory unit 33. The driving unit 31 and the memory unit 33 electrically connect with the processing unit 32. The memory unit 33 stores video data. The driving unit 31 electrically connects with the display panel 10 and configured for reading the video data from the memory unit 33 and driving the display panel 10 to display the video data on the main display area 11 and the secondary display area 12 simultaneously. The processing unit 32 electrically connects with the touch film 20 and is configured to receive control signals from the touch film 20. Upon receiving the control signal, the processing unit 32 processes the video data according the control signal before video data is transmitted to the driving unit 31.

For example, a first input operation, e.g., continuous tap, and a second input operation, e.g., double tap, are performed on the touch film 20 and a first control signal and a second control signal are generated correspondingly. The memory unit 33 also stores a command database containing a collection of control signals and a collection of commands. Each of the control signals is associated with a command correspondingly. The processing unit can execute a command to cause the video source 30 to perform corresponding function. The first operation signal is to activate the secondary display area 12. The second operation signal is to enter a menu option.

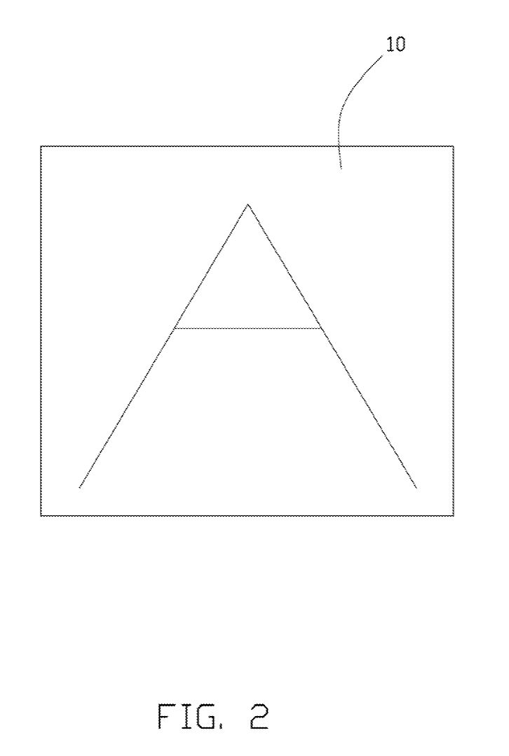

In the initial state, as shown in FIG. 2, the display panel 10 displays an integrated content “A”. When the display content of the display panel 10 needs to be operated, the first input operation is performed on the touch film 20. The touch film 20 outputs the first control signal. The processing unit 32 compares the first control signal with the control signals stored in the memory unit 33, and invokes a command correspondingly. Then, as shown in FIG. 3, the driving unit 31 divides the display panel 10 into the main display area 11 and the secondary display area 12 according to the command. The display contents of the main display area 11 remain unchanged. The secondary display area 12 displays the integrated content “A” of the display panel 10.

When a menu option of the main display area 11 needs to be selected, the second input operation is performed on the touch film 20. The touch film 20 outputs the second control signal. The processing unit 32 compares the second control signal with the control signals storing in the memory unit 33, and invokes a command correspondingly. Then, the driving unit 31 controls the main display area 11 and the secondary display area 12 simultaneously displaying contents of the selected menu option according to the command.

When the display contents is not needed, the first input operation is performed on the touch film 20 again. Therefore, the secondary display area 12 is deactivated, and the driving unit 31 controls the display panel 10 to display the integrate contents “A”.

It will be understood that the above particular embodiments and methods are shown and described by way of illustration only. The principles and the features of the present invention may be employed in various and numerous embodiment thereof without departing from the scope of the invention as claimed. The above-described embodiments illustrate the scope of the invention but do not restrict the scope of the invention.

What is claimed is:

1. A display integrated with touch control function comprising:
a display panel divided into a main display area and a secondary display area, the main display area is larger than the secondary display area;
a transparent touch film mounted on the secondary display area; and
a video source electrically connecting with the display panel and the touch film, the video source generates different commands according to different type of operation performed on the touch film, and controls display contents of the main display area and the secondary display area according to the commands.

2. The display integrated with touch control function in claim 1, wherein the secondary display area is located in an arbitrary position of the display panel, where the readability of the main display area is not greatly influenced by the secondary display area.

3. The display integrated with touch control function in claim 2, wherein the secondary display area is positioned in the right-bottom corner of the display panel.

4. The display integrated with touch control function in claim 1, wherein the video source comprising a driving unit, a memory unit, and a processing unit connects between the driving unit and the memory unit, the driving unit connects with the touch film, and the processing unit connects with the display panel.

5. The display integrated with touch control function in claim 4, wherein a first input operation and a second input operation are performed on the touch film and a corresponding first control signal and a second control signal are generated; the memory unit stores a command database comprises a collection of control signals and a collection of commands correspondingly.

6. The display integrated with touch control function in claim 5, wherein the first input operation is performed on the touch film and generates a first control signal, the secondary display area is activated according to a command corresponded to the first control signal.

7. The display integrated with touch control function in claim 6, wherein the first input operation is continuous tap.

8. The display integrated with touch control function in claim 5, wherein the second input operation is performed on the touch film and generates a second control signal, a menu option is selected according to a command corresponded to the second control signal.

9. The display integrated with touch control function in claim 8, wherein the second input operation is double tap.
